(19) United States
(12) Patent Application Publication
(10) Pub. No.: US 2015/0271413 A1
(43) Pub. Date: Sep. 24, 2015

(54) ELECTRONIC DEVICE AND METHOD FOR VIEWING IMAGES THEREOF

(71) Applicant: Acer Incorporated, New Taipei City (TW)

(72) Inventor: You-Gang Kuo, New Taipei City (TW)

(21) Appl. No.: 14/555,696

(22) Filed: Nov. 28, 2014

(30) Foreign Application Priority Data
Mar. 19, 2014 (TW) 103110326

(51) Int. Cl. H04N 5/232; H04N 5/77

(52) U.S. Cl. CPC H04N 5/23293; H04N 5/772

(57) ABSTRACT

An electronic device and a method for viewing images thereof are provided. In the method, a plurality of images are obtained, where the images corresponds to a plurality of information files. The information files are read to obtain a plurality of continuous-shooting images from the images. When a number of the continuous-shooting images is greater than a set value, the continuous-shooting images are integrated into an image combination. The image combination is displayed on one of a plurality of blocks divided in a touch screen. Therefore, the continuous-shooting images can be displayed by overlapping or animation, and the convenience of viewing images is improved accordingly.

### CROSS-REFERENCE TO RELATED APPLICATION

This application claims the priority benefit of Taiwan application serial no. 103110326, filed on Mar. 19, 2014. The entirety of the above-mentioned patent application is hereby incorporated by reference herein and made a part of this specification.

### TECHNICAL FIELD

The present invention relates to an electronic device and a method for viewing images thereof, in particular, to an electronic device and a method for viewing images thereof associated with continuous-shooting images.

### BACKGROUND

In the current information age, reliance on electronic devices is increasing day by day. For example, portable electronic devices equipped with cameras have become mainstream, and have already become indispensable tools in the life of modern man. In recent years, the use of various types of image capture devices, such as digital cameras and cell phones with image capture functions, has become increasingly popular. Among them, to let a user take more vivid images, or to allow the user to capture precious moments, a continuous-shooting function has been widely installed on image capture devices.

However, even though the continuous-shooting function can help the user to take even more satisfactory images, it also produces a large number of similar pictures, which may cause inconvenience to the user viewing the pictures. For example, typical image viewing programs can use a plurality of blocks in a touch screen to respectively display a plurality of images for users to view. But, if these images include a large amount of continuous-shooting images, the continuous-shooting images may take up all the space in the above blocks, causing the user to first need to adjust the display screen to display other images, for example through dragging operations on the touch screen, to drag other non continuous-shooting images to the display screen, to be able to be viewed.

### SUMMARY

Accordingly, the present invention is directed to an electronic device and a method for viewing images thereof, which are capable of determining continuous-shooting images by viewing the information files, and displaying the continuous-shooting images by using an overlapping display image or an animation based on the number of continuous-shooting images. Accordingly, the convenience of viewing or browsing through images for a user can be enhanced.

The method for viewing images of the invention is adapted for an electronic device including a screen. In the method, a plurality of images are obtained, wherein the images correspond to a plurality of information files. The information files are read to obtain a plurality of continuous-shooting images from the images. When a number of the continuous-shooting images is greater than a set value, the continuous-shooting images are integrated into an image combination, and the image combination is displayed in one of a plurality of blocks divided in the screen.

In an embodiment of the present invention, the step of reading the information files to obtain the continuous-shooting images from the images includes following steps. A plurality of time data are read from the information files. The time data are calculated to obtain a time difference between a first image and a second image of the images, wherein the first image and the second image are sequentially adjacent in the images. Whether the time difference is smaller than a time threshold is determined, and when the time difference is smaller than the time threshold, that the first image and the second image are determined to be the continuous-shooting images.

In an embodiment of the present invention, the step of reading the information files to obtain the continuous-shooting images from the images includes following steps. The information files of a first image and a second image which are sequentially adjacent in the images are read to determine whether each of the information files comprises an identification information. When each of the information files of the first image and the second image respectively includes the identification information, the first image and the second image are determined to be the continuous-shooting images.

In an embodiment of the present invention, before the step of obtaining the images, the method further includes following steps. When an image capture unit captures the continuous-shooting images using a continuous-shooting mode, the identification information is written into each of the information files of the continuous-shooting images.

In an embodiment of the present invention, before the step of reading the information files to obtain the continuous-shooting images from the images, the method further includes following steps. Pixels of the first image and pixels of the second image which are sequentially adjacent in the images are compared to obtain a degree of changing between the first image and the second image. When the degree of changing is smaller than a changing threshold, the identification information is written into each of the information files of the first image and the second image.

In an embodiment of the present invention, the step of when the number of the continuous-shooting images is greater than the set value, integrating the continuous-shooting images into the image combination includes following steps. The information files of the continuous-shooting images are read to obtain a plurality of thumbnails corresponding to the continuous-shooting images. The continuous-shooting images are stacked into a picture to generate an overlapping display image as the image combination.

In an embodiment of the present invention, the step of when the number of the continuous-shooting images is greater than the set value, integrating the continuous-shooting images into the image combination includes following steps. The continuous-shooting images are sequentially combined into an animation as the image combination according to the time data and a set playback speed.

In an embodiment of the present invention, the step of reading the information files to obtain the continuous-shooting images from the images further includes following steps. A device serial number is read from each of the information files to classify the images.

The electronic device of the invention includes a screen, a storage unit and a processing unit. The processing unit is coupled to the screen and the storage unit. The processing unit obtains a plurality of images, wherein the images correspond to a plurality of information files. The processing unit reads the information files to obtain a plurality of continuous-shooting images from the images. When a number of the continuous-shooting images is greater than a set value, the processing unit integrates the continuous-shooting images into an image combination, and displays the image combination on one of the plurality of blocks divided in the screen.

In an embodiment of the present invention, the processing unit reads a plurality of time data from the information files, calculates the time data to obtain a time difference between a first image and a second image of the images, wherein the first image and the second image are sequentially adjacent in the images, determines whether the time difference is smaller than a time threshold, and when the time difference is smaller than the time threshold, determines that the first image and the second image are the continuous-shooting images.

In an embodiment of the present invention, the processing unit reads the information files of a first image and a second image which are sequentially adjacent in the images to determine whether each of the information files includes an identification information, and when each of the information files of the first image and the second image respectively includes the identification information, determines that the first image and the second image are the continuous-shooting images.

In an embodiment of the present invention, the electronic device further includes an image capture unit. When the image capture unit captures the continuous-shooting images using a continuous-shooting mode, the processing unit writes the identification information into each of the information files of the continuous-shooting images.

In an embodiment of the present invention, the processing unit further compares each of pixels of the first image and the second image which are sequentially adjacent in the images to obtain a degree of changing between the first image and the second image, and when the degree of changing is smaller than a changing threshold, the processing unit writes the identification information into each of the information files of the first image and the second image.

In an embodiment of the present invention, the processing unit reads the information files of the continuous-shooting images to obtain a plurality of thumbnails corresponding to the continuous-shooting images, and stacks the continuous-shooting images into a picture to generate an overlapping display image as the image combination.

In an embodiment of the present invention, the processing unit sequentially combines the continuous-shooting images into an animation as the image combination according to the time data and a set playback speed.

In an embodiment of the present invention, the processing unit further reads a device serial number from each of the information files to classify the images.

Based on the above, the proposed electronic device and the method for viewing images thereof are capable of viewing the shooting time recorded in each of the information files, or viewing whether the information file recorded identification information corresponding to continuous-shooting images, so as to determine whether an image is one of the continuous-shooting images. Accordingly, after determined, the continuous-shooting images can be displayed by using an overlapping display image or an animation according to the number of the continuous-shooting images. In this way, the convenience of viewing or browsing through images for the user is enhanced.

In order to make the aforementioned features and advantages of the invention more comprehensible, embodiments accompanying figures are described in detail below.

### BRIEF DESCRIPTION OF THE DRAWINGS

The accompanying drawings are included to provide further understanding and are incorporated in and constitute a part of this specification. The drawings illustrate exemplary embodiments and, together with the description, serve to explain the principles of the invention.

FIG. 1 is a block diagram of an electronic device according to an embodiment of the present invention.

FIG. 2 is a flow chart of a method for viewing images according to an embodiment of the present invention.

FIG. 3 is a schematic diagram of an electronic device according to an embodiment of the present invention.

FIG. 4 is a flow chart of a method for viewing images according to an embodiment of the present invention.

FIG. 5 is a flow chart of a method for viewing images according to an embodiment of the present invention.

FIG. 6 is a flow chart of a method for viewing images according to an embodiment of the present invention.

FIG. 7 is a flow chart of a method for viewing images according to an embodiment of the present invention.

### DESCRIPTION OF THE EMBODIMENTS

Information of an image is generally stored as an exchangeable image file (hereinafter referred to as EXIF). The EXIF file is typically produced when an electronic device takes a picture, and can include a thumbnail for displaying on the screen, a shooting time, a device serial number of an image capture device, and such related information. Additionally, the EXIF file also allows a user to edit for writing and recording image parameters into the fields of the EXIF file. Thus, the embodiments of the present invention provide an electronic device and a method of viewing images thereof that are capable of finding continuous-shooting images from multiple images by viewing the shooting time in the information file, or by viewing the identification information written into the information file corresponding to the continuous-shooting images. Also, with the proposed method, the continuous-shooting images can be further displayed on a screen by using an overlapping display image or an animation according to a number of the continuous-shooting images. Accordingly, the convenience of viewing images for a user can be improved. To make the contents of the invention more clear, embodiments will be examined below, as examples that the invention is indeed able to be implemented.

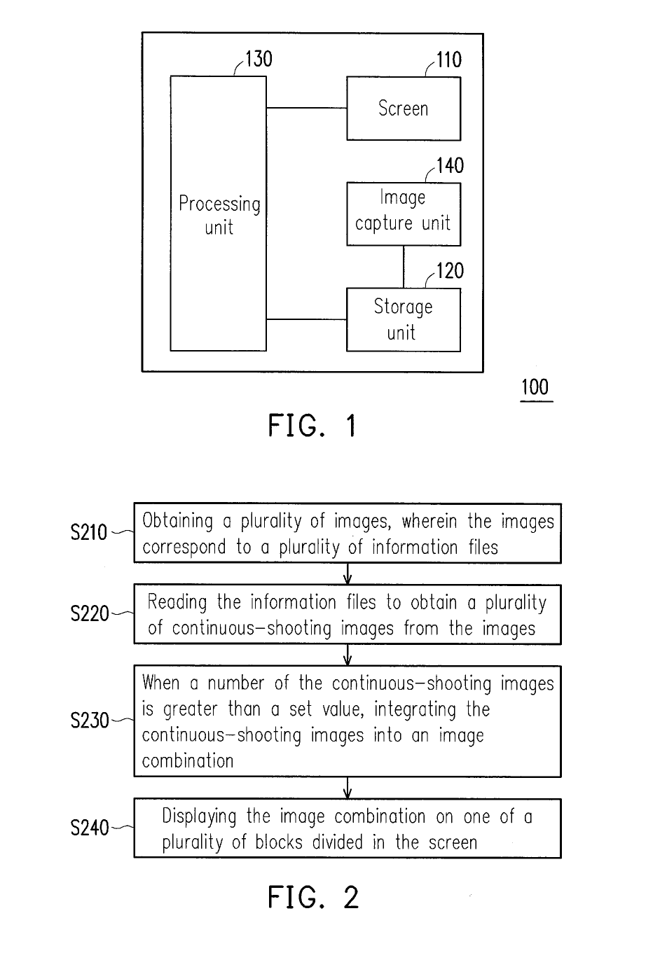

FIG. 1 is a block diagram of an electronic device according to an embodiment of the present invention. Referring to FIG. 1, the electronic device 100 includes a screen 110, a storage unit 120, and a processing unit 130. The electronic device 100 of the embodiment is, for example, a smart phone, a tablet, a personal digital assistant (PDA), a laptop computer, or the like.

The screen 110 is, for example, a liquid crystal display (LCD), a light emitting diode (LED) display, or other suitable displays. In some embodiments, the screen 110 can combine the above display unit with a resistive or capacitive touch panel, so as to simultaneously provide a display and control function, and the invention is not limited thereto. In the present embodiment, the display of the screen 110 can be divided into a plurality of blocks, and the blocks is used for respectively displaying a plurality of images stored in the electronic device 100, so as to allow the user to browse through and view images. And generally, the above plurality of blocks can be used for sequentially displaying each individual image according to the shooting times of the images.

The storage unit 120 can be any type of stationary or portable random access memory (RAM), read-only memory (ROM), flash memory, or similar elements or a combination of the above elements. In the present embodiment, the storage unit 120 can be used for recording the above images.

The processing unit 130 is coupled to the storage unit 120. The processing unit 130 is, for example, a central processing unit (CPU), a graphic processing unit (GPU), a programmable controller, a digital signal processor (DSP), or other general purpose or special purpose programmable microprocessor, etc. In the present embodiment, the processing unit 130 is used for managing and control the electronic device 100, to realize the proposed method for viewing images.

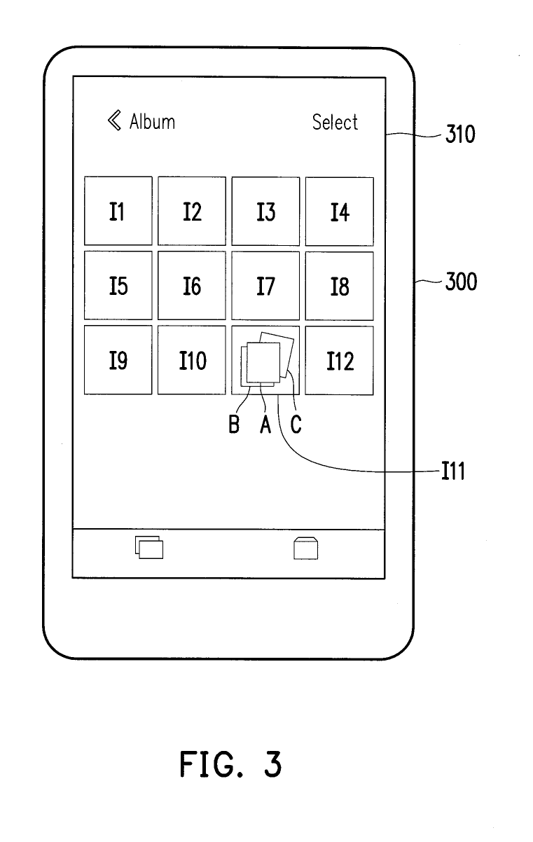

FIG. 2 is a flow chart of a method for viewing images according to an embodiment of the present invention, and the method of this embodiment can be applicable to the electronic device 100 in FIG. 1. FIG. 3 is a schematic diagram of the electronic device according to an embodiment of the present invention. Below, elements of electronic device 100 are combined with the schematic diagram in FIG. 3, to explain the detailed process of the method for viewing images in FIG. 2.

In step S210, the processing unit 130 obtains a plurality of images, wherein the images correspond to a plurality of information files. Specifically, the processing unit 130 can access the storage unit 120 for obtaining the images stored in the storage unit 120. The information file of the image for example, is an EXIF file, but is not limited thereto. Generally, image related information can be stored in the EXIF file of each of the images. The EXIF file may include not only a thumbnail for displaying on the screen, but also a file name, a file time, a shooting time, dimensions, a rotation angle, effects, and other image information.

Next, in step S220, the processing unit 130 can read the information files to obtain a plurality of continuous-shooting images from the images. The continuous-shooting images here for example, are captured through a continuous-shooting mode, which is a function for continuously capturing multiple images for a set time interval during the shutter is pressed once, of an image capture device. Additionally, the continuous-shooting images can also be continuously captured by the user manually pressing down on the shutter multiple of times. The above image capture device for example, can include fixed focus optical lens or optical zoom lens, and a photosensitive element, such as a charge coupled device (CCD) or complementary metal-oxide semiconductor (CMOS). In some embodiments, the electronic device 100 can also have an image capture unit 140, and the image capture unit 140 may include the above image capture devices. When a shutter signal is detected, the image capture unit 140 executes an action to capture images.

Accordingly, in an embodiment, the processing unit 130 can utilize the time difference in the shooting times between the images to determine whether the images are continuous-shooting images based on the shooting times recorded in the information files. This time difference can be preset as, for example, 1 second or 0.5 second, and can be set freely according to user needs, which is not limited thereto. Additionally, in an embodiment of the present invention, the processing unit 130 can also utilize identification information corresponding to the continuous-shooting images in the information files to determine whether an image is a continuous-shooting image or not. The identification information can be written into the information file of each of the image according to whether the image is captured by using the continuous-shooting mode by the image capture unit 140, or according to the processing unit 130 determines that each of the adjacent images is a continuous-shooting image after an image recognition between the adjacent images is executed. Alternatively, in another embodiment, the processing unit 130 can also combine the above mechanisms for determining the continuous-shooting images.

Continuing with the flow chart of FIG. 2, in step S230, when a number of the continuous-shooting images is greater than a set value, the processing unit 130 can integrate the continuous-shooting images into an image combination. In step S240, the processing unit 130 can display the image combination on one of the plurality of blocks divided in the screen 110. Herein, the blocks divided in the screen 110 may indicate regions for viewing images in the screen 110, such as blocks I1˜I12 as illustrated in FIG. 3. Moreover, based on the set value, the processing unit 130 can then determine to display one single image or multiple images in each of the blocks I1˜I12. With a set value of 2 for example, when the processing unit 130 obtains 2 or less than 2 continuous-shooting images in step S220, the processing unit 130 individually and sequentially displays the continuous-shooting images obtained in the blocks as shown in FIG. 3 (for example, when there are 2 continuous-shooting images obtained, the processing unit 130 can sequentially display the 2 continuous-shooting images in block sections 16, 17). The above-mentioned corresponds to the typical method for viewing images. As for when there are 3 continuous-shooting images or more obtained by the processing unit 130, the processing unit 130 can then integrate the continuous-shooting images into the image combination by using an overlapping display image or an animation for display the above continuous-shooting images in the same block. As shown in the example of FIG. 3, the processing unit 130 can display the overlapped continuous-shooting images A, B, C in block section I11.

Thus, the present embodiment can allow the user to view each image in a glance through the browsing display when there are not many continuous-shooting images, and when the number of continuous-shooting image meets a set value, then displays the continuous-shooting images in an image combination format. Thus, it can enhance user convenience and interest during image viewing.

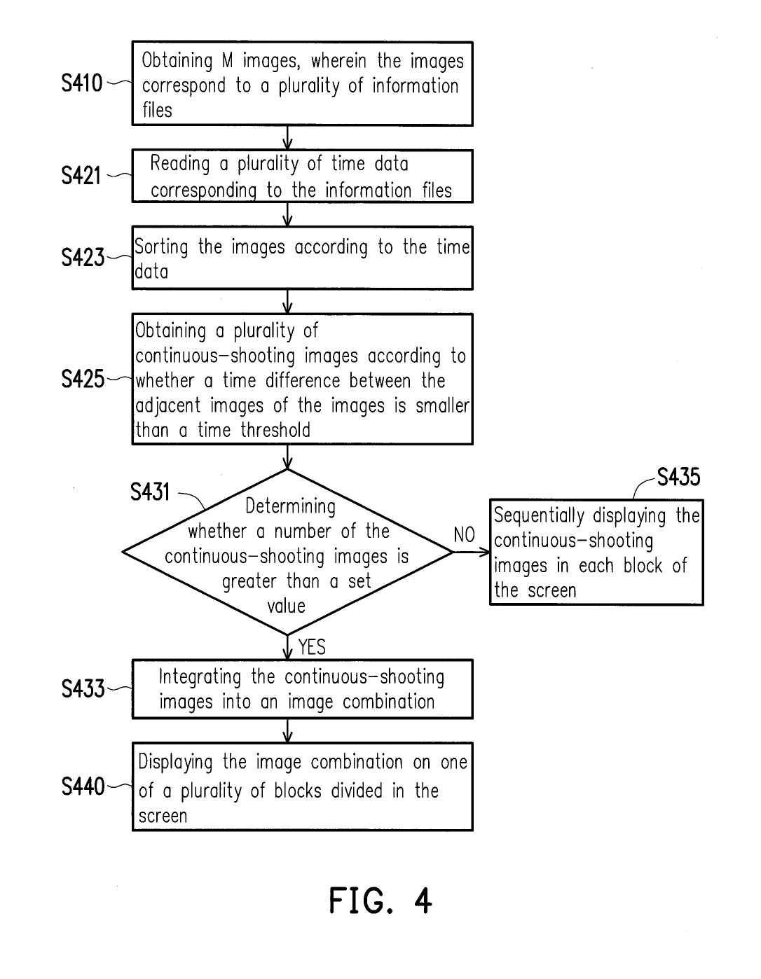

Below, is a detailed description of the method for viewing images provided by an embodiment of the present invention, according to a mechanism of determining continuous-shooting images using the time difference between sequentially adjacent images as an example. Referring to FIG. 4, FIG. 4 is a flow chart of a method for viewing images according to an embodiment of the present invention, and can be adapted for the electronic device 100 of FIG. 1. In step S410, the processing unit 130 obtains M images, wherein the images correspond to a plurality of information files, and M is an integer greater than 1. In step S421, the processing unit 130 can read a plurality of time data corresponding to the information files, and in step S423, the processing unit 130 can sort the images according to the time data, each of which can be a shooting time when each of the images is captured. In other words, the processing unit 130 of the present embodiment can read the information files of the above M images, and after obtaining the shooting time of each, the processing unit 130 adjusts the images into an image sequence sorted in accordance with the time.

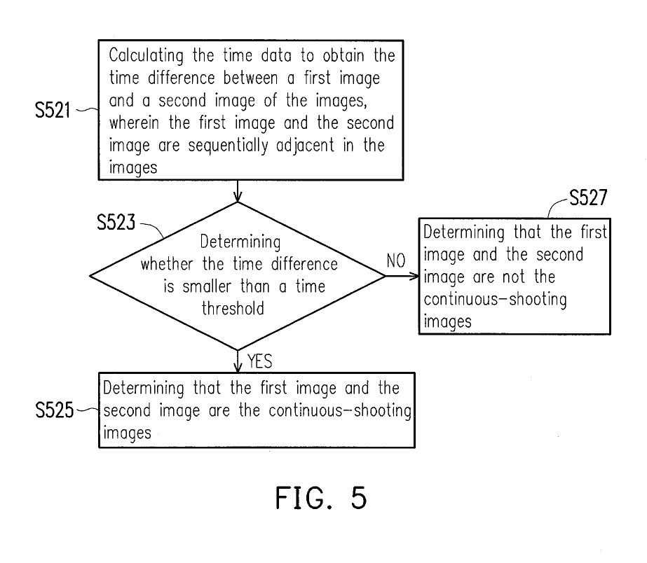

In step S425, the processing unit 130 can obtain a plurality of continuous-shooting images, according to whether a time difference between the adjacent images of the M images is smaller than a time threshold. In more detail, in the process mentioned above, the processing unit 130 has sorted the M images, and therefore the above adjacent images of the images refers to two images that have the closest shooting time among the M images. Furthermore, it is worth to note that the continuous-shooting images are typically multiple images captured of a similar picture in a short period of time. Thus, utilizing the above characteristic, the processing unit 130 can determine whether each of the adjacent images is a continuous-shooting image, by determining whether the time difference of the adjacent images is smaller than the time threshold. The flow chart of FIG. 5 is used to further describe a mechanism of determining the continuous-shooting images performed by the processing unit 130.

Referring to FIG. 5, FIG. 5 is a flow chart of a method for viewing images according to an embodiment of the invention, which are details of step S425 in FIG. 4. After reading the plurality of time data from the information files in step S421, in step S521, the processing unit 130 calculates the time data to obtain the time difference between a first image and a second image of the images, wherein the first image and the second image are sequentially adjacent in the images. In step S523, the processing unit 130 determines whether the time difference is smaller than a time threshold. When the time difference is smaller than the time threshold, in step S525, the processing unit 130 determines that the first image and the second image are the continuous-shooting images. On the contrary, when the time difference is not smaller than the time threshold, in step S527, the processing unit 130 then determines that the first image and the second image are not the continuous-shooting images.

Thus, by utilizing the determination mechanism in FIG. 5, the processing unit 130 can sequentially select two adjacent images from the obtained M images, and respectively proceed with the above time difference determination for the selected two adjacent images in every selection, so as to obtain the continuous-shooting images in the obtained M images.

Referring back to the flow chart of FIG. 4, after the processing unit 130 obtains the continuous-shooting images, in step S431; the processing unit 130 can further determine whether a number of the continuous-shooting images is greater than a set value. When the number of the continuous-shooting images is greater than the set value, the processing unit 130 integrates the continuous-shooting images into an image combination in step S433, and displays the image combination on one of a plurality of blocks divided in the screen in step S440. On the other hand, when the number of continuous-shooting images is not greater than the set value, the processing unit 130 then respectively and sequentially displays the continuous-shooting images in each block of the screen in step S435.

In further detail, the above image combination may include different displaying formats for viewing image. For example, the image combination may correspond to overlapping display the images, or may also correspond to combine the images into an animation for playback, etc. More specifically, in an embodiment of the present invention, the processing unit 130 can read the information files of the continuous-shooting images to obtain a plurality of thumbnails corresponding to the continuous-shooting images, and stack the continuous-shooting images into a picture to generate an overlapping display image as the image combination. The thumbnails refer to those stored in the EXIF files of the images. Namely, the processing unit 130 utilizes the thumbnails originally stored in the EXIF files to produce the image combination, and as a result, can more quickly display the above image combination on the screen 110.

In another embodiment, the processing unit 130 can then sequentially combine the obtained continuous-shooting images into the animation as the image combination according to the time data and a set playback speed. Here the set playback speed can be, for example, a speed of 16 images per second, in order to achieve the effect of continuous playback when the user views.

It should be noted that the above image combination is used for presenting multiple continuous-shooting images in a single block of the screen 110. If the user desires to view one of the above images individually, the processing unit 130 can also accept an operation performed to the block by the user, and consequently display an individual image of the image combination on the screen 110. The images can be displayed by using, for example, multiple blocks similarly, scrolling of the images, or also other formats by the processing unit 130, which is not limited thereto.

Accordingly, the proposed method for viewing images is capable of reading the shooting times from the information files to determine whether the images are continuous-shooting images, and, displaying the continuous-shooting images by using an overlapping display image or an animation according to the number of the continuous-shooting images. As a result, the user convenience for viewing images is enhanced.

It should be noted that, in an embodiment, when determining the continuous-shooting images according to the time difference in step S425, the processing unit 130 also can read the device serial number from each of the information files to classify the obtained images based on whether the images are captured by the same device, which makes more accurate determinations of the continuous-shooting images. Additionally, in another embodiment, when obtaining M images in step S410, the processing unit 130 can also read the device serial numbers from the information files, so as to separate the images corresponding to different device serial numbers and respectively determine the continuous-shooting images captured by different devices

Another point worth mentioning is, the previous embodiment only obtained one set of continuous-shooting images from M images, as an example for explanation, but the proposed method for viewing images of the present embodiment is also applicable to circumstances having multiple sets of continuous-shooting images. For example, the processing unit 130 executes the determination for the first set of the continuous-shooting images according to the flows in FIG. 4 and FIG. 5. After determining there are the adjacent first and second images not belonging to the set of the continuous-shooting images in steps S523, the processing unit 130 then ends the determination of the set of the continuous-shooting images in FIG. 5 (step S425), and proceeds to step S431 to determine how to display the continuous-shooting images obtained. Later, the processing unit 130 can again determine the second set of continuous-shooting images as in the previously mentioned process according to the time difference of the adjacent images. The processing unit 130 can also separately display image combinations corresponding to each set of continuous-shooting images in different blocks in the screen 110.

Additionally, in some embodiments, the sorting adjustments executed by the processing unit 130 in process S423 can be omitted. Those skilled applying the present embodiment can determine whether ordering of the above M images by using each of the shooting times is necessary according to the design requirement for the continuous-shooting images determination process.

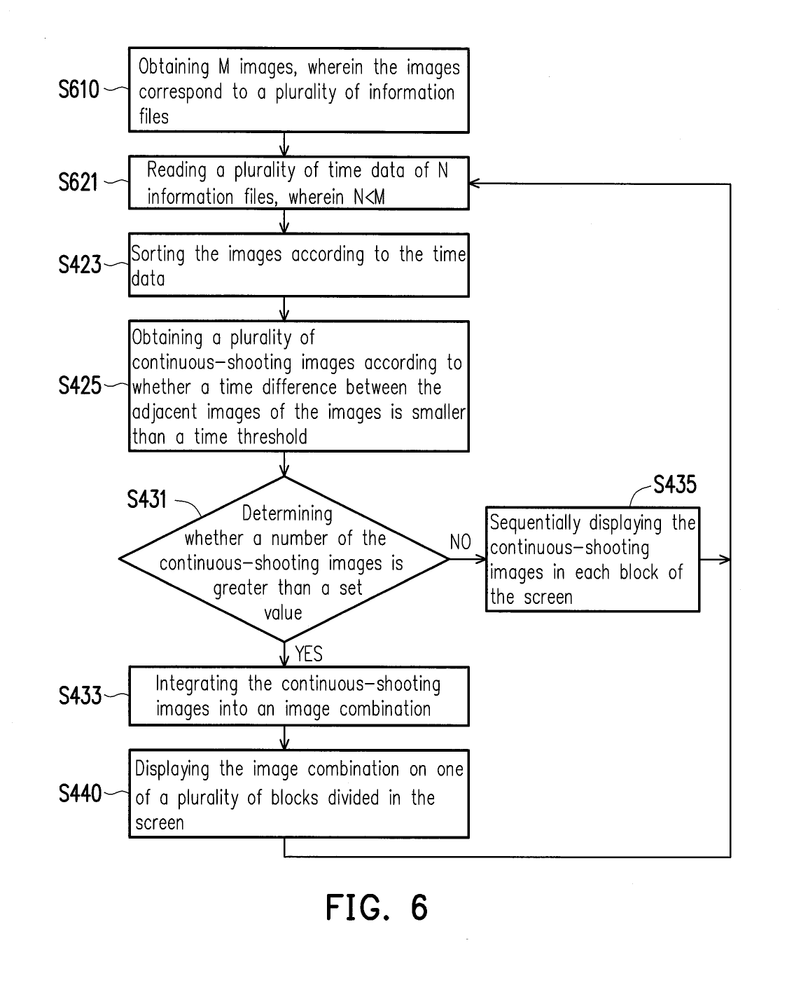

In the aforementioned embodiment, the processing unit 130 first reads the information files of all of the M images, and after executing each follow up process, the processing unit 130 then displays the images on the screen 110. Once M is a big number, the user may need to wait for a longer amount of time to be able to view the images, due to the process in FIG. 4 being executed by the processing unit 130 takes overly long. To prevent the above situation, another embodiment is provided in FIG. 6, which is capable of reading the information files of the images in batches, so as to improve the above problem of an overly long wait time. The description of the embodiment in FIG. 6 is detailed below.

Referring to FIG. 6, the embodiment in FIG. 6 is similar to the embodiment in FIG. 4, and for identical or similar processes please refers to the aforementioned. The difference lies in, after the processing unit 130 obtains M images in step S610, the processing unit 130 reads a plurality of time data of N information files in step S621, wherein N is an integer and N is smaller than M. Then, the processing unit 130 executes the follow up processes according to the flow chart of FIG. 6. After the processing unit 130 sequentially displays the continuous-shooting images and other non continuous-shooting images obtained from the above N images on to the screen (in step S435 or in step S440), the processing unit 130 will once again execute step S621, and process another N images from the M images. As a result, by using the above method of processing N images every time, when M is significantly greater than integer N, the waiting time needed to view the images can be significantly improved.

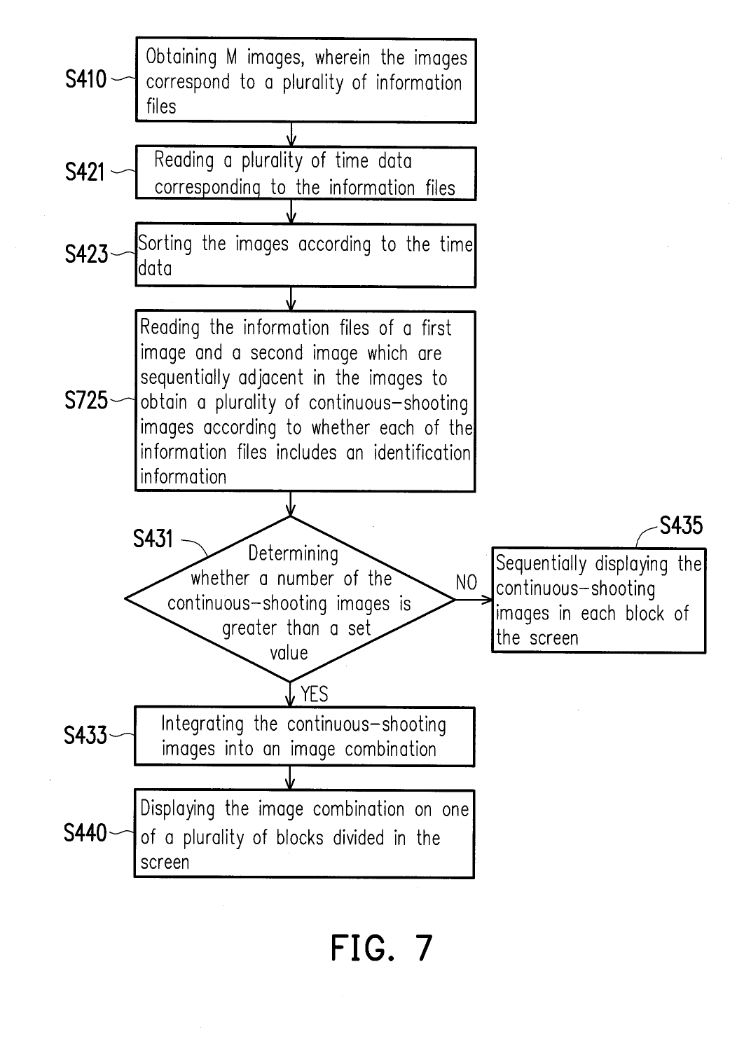

The aforementioned numerous embodiments describe the mechanism for determining continuous-shooting images according to the time difference between adjacent images performed by the processing unit 130 in detail. Below, FIG. 7 will be used to detail the mechanism for determining continuous-shooting images according to identification information by the processing unit 130.

FIG. 7 is a flow chart of a method for viewing images according to an embodiment of the present invention. Referring to FIG. 7, the present embodiment is similar to the aforementioned embodiments, therefore identical or similar details will not be repeated. The difference lies in step S725, the processing unit 130 can read the information files of a first image and a second image which are sequentially adjacent in the images to obtain a plurality of continuous-shooting images according to whether each of the information files includes an identification information. The identification information can be written into the above information file of each of the continuous-shooting images by the processing unit 130, when image capture unit 140 captures the continuous-shooting images using the continuous-shooting mode. For example, the processing unit 130 can detect a trigger signal corresponding to the case that the continuous-shooting mode is turned on in order to automatically write the above identification information into the information files of the continuous-shooting images captured.

On the other hand, since the continuous-shooting images are typically captured for similar pictures, therefore utilizing this characteristic, in another embodiment, the processing unit 130 can perform image recognition between the adjacent images obtained, so as to determine whether the adjacent images are continuous-shooting images. More specifically, the processing unit 130 can compare each of pixels of the first image and the second image which are sequentially adjacent in the images to obtain a degree of changing between the first image and the second image. When the degree of changing is smaller than a changing threshold, the processing unit 130 writes the identification information into each of the information files of the first image and the second image. The image identification above can be realized through a variety of algorithms and combinations thereof. For example, the processing unit 130 can first perform a grayscale conversion, a binary conversion or an edge detection, etc. image processing, to obtain the edge features in each of the images, and extract a feature region of interest via image segmentation, to normalize the image by vectors and matrices to calculate the degree of similarity. Therefore, after the processing unit 130 performs calculations, the matrix degree of similarity obtained can correspond to the degree of changing between the two images, and when the degree of changing is smaller than the difference threshold, the processing unit 130 can write corresponding identification information of the continuous-shooting images into each of the information files of the images. The above method of comparing the degree of changing between images is only an example, which is not limited thereto.

Therefore, the processing unit 130 can read the identification information in the information file of each of the images, and determine that each of the images whose information file includes the identification information is the continuous-shooting image. More specifically, in one embodiment, the processing unit 130 can read the information files of the first image and the second image which are sequentially adjacent in the images to determine whether each of the information files includes an identification information, and when each of the information files of the first image and the second image respectively includes the identification information, the processing unit 130 can determine that the first image and the second image are the continuous-shooting images. The processing unit 130 can sequentially read the obtained M images through utilizing the above method, and therefore obtain the plurality of continuous-shooting images.

Accordingly, the proposed method for viewing images provided by the present embodiment is also capable of determining whether the images is a continuous-shooting images by reading the identification information corresponding to the continuous-shooting image in the information file of the image. It should be noted that whether the step S421 and step S423 of the present embodiment should be executed or not can be determined based on the designing requirements, which is not limited thereto.

In summary, the embodiments of the present application provide an electronic device and a method for viewing images thereof that are capable of determining whether the image is a continuous-shooting image, by only viewing the shooting time recorded in each of the information files, or by viewing whether the information file records the identification information corresponding to the continuous-shooting image. Furthermore, the proposed method can also classify the images by viewing the device serial number in each of the information files, making the determination of the continuous-shooting images more accurate. As a result, after the continuous-shooting images are determined, the convenience of viewing or browsing through the images for the user can be further enhanced by displaying the continuous-shooting images using an overlapping display image or an animation according to the number of the continuous-shooting images. Additionally, the problem of an overly long wait time for displaying images can also be improved by determining the continuous-shooting images by reading the information files in batches.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for viewing images, adapted for an electronic device comprising a screen, the method for viewing images comprising:
obtaining a plurality of images, wherein the images correspond to a plurality of information files;
reading the information files to obtain a plurality of continuous-shooting images from the images;
when a number of the continuous-shooting images is greater than a set value, integrating the continuous-shooting images into an image combination; and
displaying the image combination on one of a plurality of blocks divided in the screen.

2. The method for viewing images as claimed in claim 1, wherein the step of reading the information files to obtain the continuous-shooting images from the images comprises:
reading a plurality of time data from the information files;
calculating the time data to obtain a time difference between a first image and a second image of the images, wherein the first image and the second image are sequentially adjacent in the images;
determining whether the time difference is smaller than a time threshold; and
when the time difference is smaller than the time threshold, determining that the first image and the second image are the continuous-shooting images.

3. The method for viewing images as claimed in claim 1, wherein the step of reading the information files to obtain the continuous-shooting images from the images comprises:
reading the information files of a first image and a second image which are sequentially adjacent in the images to determine whether each of the information files comprises an identification information; and
when each of the information files of the first image and the second image respectively comprises the identification information, determining that the first image and the second image are the continuous-shooting images.

4. The method for viewing images as claimed in claim 3, wherein before the step of obtaining the images, the method further comprises:
when an image capture unit captures the continuous-shooting images using a continuous-shooting mode, writing the identification information into each of the information files of the continuous-shooting images.

5. The method for viewing images as claimed in claim 3, wherein before the step of reading the information files to obtain the continuous-shooting images from the images, the method further comprises:
comparing each of pixels of the first image and the second image which are sequentially adjacent in the images to obtain a degree of changing between the first image and the second image; and
when the degree of changing is smaller than a changing threshold, writing the identification information into each of the information files of the first image and the second image.

6. The method for viewing images as claimed in claim 1, wherein the step of when the number of the continuous-shooting images is greater than the set value, integrating the continuous-shooting images into the image combination comprises:
reading the information files of the continuous-shooting images to obtain a plurality of thumbnails corresponding to the continuous-shooting images; and
stacking the continuous-shooting images into a picture to generate an overlapping display image as the image combination.

7. The method for viewing images as claimed in claim 1, wherein the step of when the number of the continuous-shooting images is greater than the set value, integrating the continuous-shooting images into the image combination comprises:
sequentially combining the continuous-shooting images into an animation as the image combination according to the time data and a set playback speed.

8. The method for viewing images as claimed in claim 1, wherein the step of reading the information files to obtain the continuous-shooting images from the images further comprises:
reading a device serial number from each of the information files to classify the images.

9. An electronic device comprising:
a screen;
a storage unit; and
a processing unit, coupled to the screen and the storage unit, obtaining a plurality of images, wherein the images correspond to a plurality of information files, reading the information files to obtain a plurality of continuous-shooting images from the images, when a number of the continuous-shooting images is greater than a set value, integrating the continuous-shooting images into an image combination, and displaying the image combination on one of a plurality of blocks divided in the screen.

10. The electronic device as claimed in claim 9, wherein the processing unit reads a plurality of time data from the information files, calculates the time data to obtain a time difference between a first image and a second image of the images, wherein the first image and the second image are sequentially adjacent in the images, determines whether the time difference is smaller than a time threshold, and when the time difference is smaller than the time threshold, determines that the first image and the second image are the continuous-shooting images.

11. The electronic device as claimed in claim 9, wherein the processing unit reads the information files of a first image and a second image which are sequentially adjacent in the images to determine whether each of the information files comprises an identification information, and when each of the information files of the first image and the second image respectively comprises the identification information, determines that the first image and the second image are the continuous-shooting images.

12. The electronic device as claimed in claim 11, wherein the electronic device further comprises:
an image capture unit, wherein when the image capture unit captures the continuous-shooting images using a continuous-shooting mode, the processing unit writes the identification information into each of the information files of the continuous-shooting images.

13. The electronic device as claimed in claim 11, wherein the processing unit further compares each of pixels of the first image and the second image which are sequentially adjacent in the images to obtain a degree of changing between the first image and the second image, and when the degree of changing is smaller than a changing threshold, the processing unit writes the identification information into each of the information files of the first image and the second image.

14. The electronic device as claimed in claim 9, wherein the processing unit reads the information files of the continuous-shooting images to obtain a plurality of thumbnails corresponding to the continuous-shooting images, and stacks the continuous-shooting images into a picture to generate an overlapping display image as the image combination.

15. The electronic device as claimed in claim 9, wherein the processing unit sequentially combines the continuous-shooting images into an animation as the image combination according to the time data and a set playback speed.

16. The electronic device as claimed in claim 9, wherein the processing unit further reads a device serial number from each of the information files to classify the images.
